(19) United States
(12) Patent Application Publication
(10) Pub. No.: US 2003/0046122 A1
(43) Pub. Date: Mar. 6, 2003

(54) Systems and methods for managing printing device replaceable components for multiple organizations

(76) Inventor: Richard S. Seymour, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/942,225

(22) Filed: Aug. 29, 2001

(51) Int. Cl. G06F 17/60

(52) U.S. Cl. 705/7

(57) ABSTRACT

A rules-based printing device component management system and methods for use are described that allow a printing device component vendor to monitor printer component conditions in multiple organizations. The printer component conditions are compared with one or more rules defined for the printer and its components to determine if a printer component requires replacement. The rules may be defined by the organization or the vendor and may be stored at a vendor site to efficiently manage replacement of depleted or broken printer components.

### TECHNICAL FIELD

This invention generally relates to management of printing device component inventories. More particularly, the invention(s) described herein relate to central monitoring of printer component conditions in printers of multiple organizations for the occurrence of a printer component event that indicates the need for a replacement for the printer component in which the event occurred.

### BACKGROUND

Management of replaceable components for printing devices is a critical task for properly maintaining a printing device in an operable state. This is true whether an enterprise or organization has only one printing device or if it has several to hundreds of printing devices. Of course, as the number of printing devices to be managed increases, so does the difficulty of managing replaceable component inventories for the printing devices.

Most types of printing devices are equipped with replaceable components that have a life cycle during which the replaceable components are functional. At the end of the life cycle of a replaceable component, the component must be replaced for the printing device to continue to function properly.

For example, a toner cartridge is installed in a laser printer to provide toner for the printing process. As documents are printed, the toner supply is gradually depleted. When the toner supply is completely exhausted, the printer cannot print any further documents until the toner cartridge is replaced.

Unless a printer user has prepared in advance and has procured a new toner cartridge, then a problem arises when the toner cartridge runs out of toner and the user must delay completion of the print job. On the other hand, a user of multiple printers such as a business must keep an inventory of toner cartridges so an operational toner cartridge is always available. Having to keep such an inventory of toner cartridges imposes a financial burden on a business and utilizes valuable human resource time dealing with inventory control.

Large enterprises often require maintenance of a large number of replaceable components for enterprise printing devices so that printing device down time can be reduced to a minimum. However, maintaining such an inventory can be expensive, especially if the enterprise has several different makes and models of printing devices.

Some “just-in-time” inventory systems have been proposed that require a printing device to notify a component distributor when the printing device requires a component to be replaced. These systems require component vendors serving the printing devices to handle the printing device transaction separately, even if the printing device is a single part of a large organization or enterprise.

### SUMMARY

A rules-based printing device component management system and methods for use are described that allow a printing device component vendor to monitor printer component conditions in all (or most) of the printers in multiple organizations. The organizations may be different organizations within the same enterprise, or they may be separate enterprises.

The printer component conditions that are monitored are compared with one or more rules defined for the printing devices and its components to determine if a printing device component requires replacement. The rules may be defined by the organization that uses the printing devices or by the vendor, and they may be stored at a vendor site to efficiently manage replacement of depleted or broken printer components.

A vendor maintains a system that presents an interface to an organization that allows the organization to define rules for printing device component conditions. When a condition in a printing device component satisfies one or more of the rules, then a printer component event occurs that indicates that the printing device component needs to be replaced. When a printer component event occurs, a replacement component is shipped or ordered to be shipped to a location of the printing device that requires the replacement component.

This allows the organization to set its own rules as to when a printing device component should be ordered. It also allows the organization to remain removed from the monitoring and ordering process once the system is in place. The vendor then monitors for conditions that indicate a replacement component should be delivered to the organization and the vendor then sends a replacement component to the organization.

For example, if a toner low signal is emitted by a laser printer, and the vendor's rules-based system for the organization that uses the laser printer includes a rule stating that a replacement toner cartridge should be shipped to the organization for a printer that exhibits a toner low signal, then the vendor automatically ships a replacement toner cartridge to the organization.

This effectively provides a “just-in-time” inventory system for the organizations served by the vendor. It also allows the vendor to keep track of the printers of all of the organizations it serves. It also provides the vendor with a strong repeat customer rate, since once the system is in place, the probability is small that the customer will decide to change the vendor from whom it purchases printing device replaceable components.

### BRIEF DESCRIPTION OF THE DRAWINGS

The present invention is illustrated by way of example and not limitation in the figures of the accompanying drawings. The same numbers are used throughout the figures to reference like components and/or features.

FIG. 1 is a block diagram of a vendor system and organizations that are served by the vendor.

FIG. 2 is a block diagram of a laser printer configured to implement the rules-based printer component management system described herein.

FIG. 3 is a block diagram of a vendor system that implements the rules-based printer component management system described herein.

FIG. 4 is a flow diagram depicting a methodological implementation of the rules-based printer component management system described herein.

### DETAILED DESCRIPTION

The following description sets forth one or more specific implementations and/or embodiments of systems and methods for rules-based printing device component inventory management. The systems and methods incorporate elements recited in the appended claims. These implementations are described with specificity in order to meet statutory written description, enablement, and best-mode requirements. However, the description itself is not intended to limit the scope of this patent.

Also described herein are one or more exemplary implementations of systems and methods for applying a rules-based printer component management process. Applicant intends these exemplary implementations to be examples only. Applicant does not intend these exemplary implementations to limit the scope of the claimed present invention(s). Rather, Applicant has contemplated that the claimed present invention(s) might also be embodied and implemented in other ways, in conjunction with other present or future technologies.

Computer-Executable Instructions

An implementation of a system and/or method for rules-based management of replaceable printer components may be described in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Computer-Readable Media

An implementation of a system and/or method for rules-based management of printing device replaceable components may be stored on or transmitted across some form of computer-readable media. Computer-readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communications media” typically embodies computer-readable instructions, data structures, program modules, or other data in a modulated data signal, such as carrier wave or other transport mechanism. Communication media also includes any information delivery media.

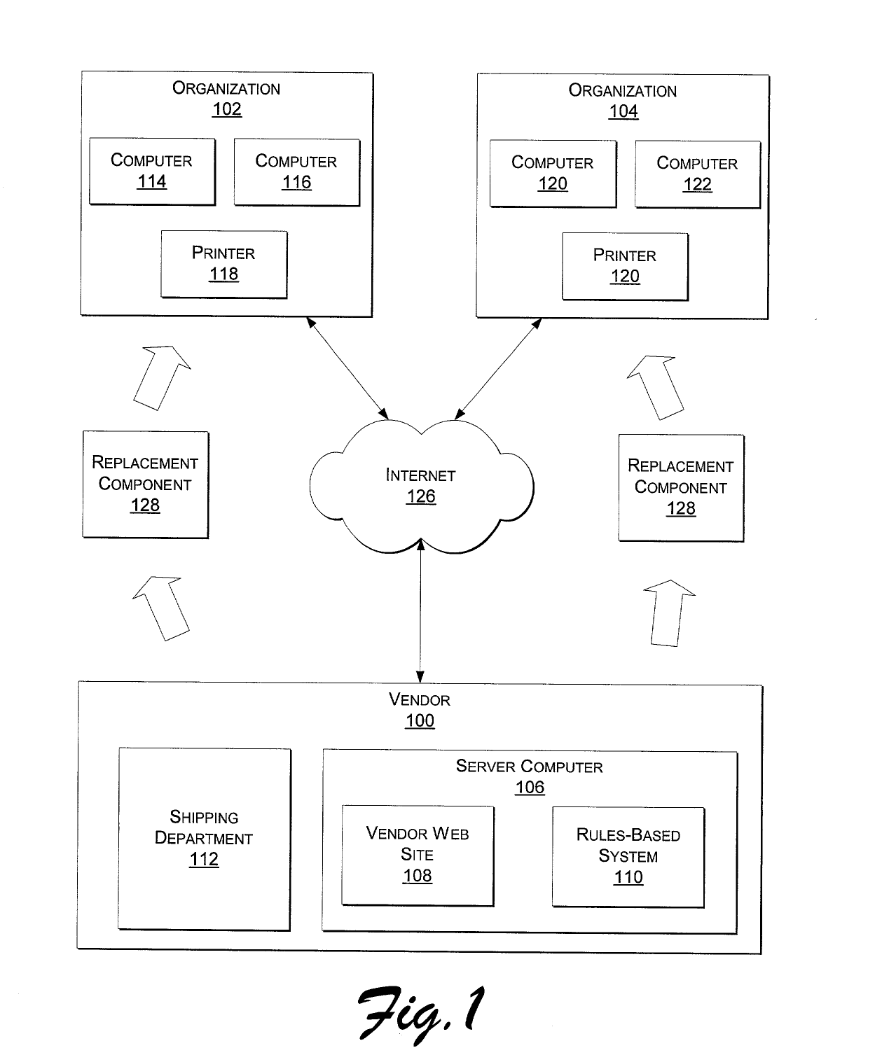

FIG. 1 is a block diagram of a vendor 100 and organizations served by the vendor 100, including organization 102 and organization 104. The vendor 100 includes a server computer 106 that operates a vendor web site 108 and a rules-based system 110 for management of printing device replaceable components. The vendor 100 also includes a shipping component 112, which may be a physical shipping department or an ordering department that notifies a physical shipping department to ship a printer component to a customer.

It is noted that the systems and methods described herein may refer to printing devices and/or printers. The use of these terms is intended to be interchangeable. Therefore, reference to a printer is not meant to limit the discussion to an actual “printer.” The term “printer” or “printing device” refers to any device having the ability to render printed characters and the like on one or more print media. Such devices include, but are not limited to, laser printer, ink jet printers, dry medium printers, dot matrix printers, facsimile machines, copy machines, plotters, and the like.

The term printer component (also referred to herein as printing device component, replaceable component or, simply component) refers to any component in a printing device that is replaceable. Such components include, but are not limited to, toner cartridges, ink cartridges, ink bladders, ribbon cartridges, dry medium cartridges, photoconductors, drums, belts, developer assemblies, fuser assemblies, cleaning rollers, oiling rollers, transfer assemblies, gear rollers, and the like.

Organization 102 includes computer 114, computer 116 and printer 118. It is noted that the computers 114, 116 and printer 118 are exemplary of many more such computers and printers that are used by organization 102. However, for convenience, only computers 114, 116 and printer 118 are shown. Organization 104 includes computer 120, computer 122 and printer 124. As mentioned above, these devices are merely exemplary of many more such devices in organization 104.

The rules-based system 110, which will be discussed in greater detail below, manages replaceable component inventory. Although the rules-based system 110 is shown as being a part of the vendor 100, it will be seen in the following discussion that the rules-based system 100 could be implemented as a part of organization 102 or 104. More specifically, the rules-based system 100 could be implemented on any computer or print server that is a part of organization 102 or 104.

The vendor 100 is configured to access the Internet 126 or other network via the server computer 106 or some other computer (not shown) used by the vendor 100. Computer 112 of organization 102 and computer 104 of organization 104 also have the capability to communicate with the Internet 126, thereby enabling the organizations 102, 104 to communicate with the vendor 100. Printer 118 and printer 124 also have the capability to communicate with the Internet 126 and, thus, the vendor 100.

The organizations 102, 104 can communicate the need for replacement components to the vendor 100 when one of the printers 118, 124 requires a new component to replace a depleted or broken replaceable component. The vendor 100 then ships replacement components 128 to organization 102 and organization 104 and, preferable, to the location of the printer 118, 124 that requires the replaceable component.

Exemplary Printing Device

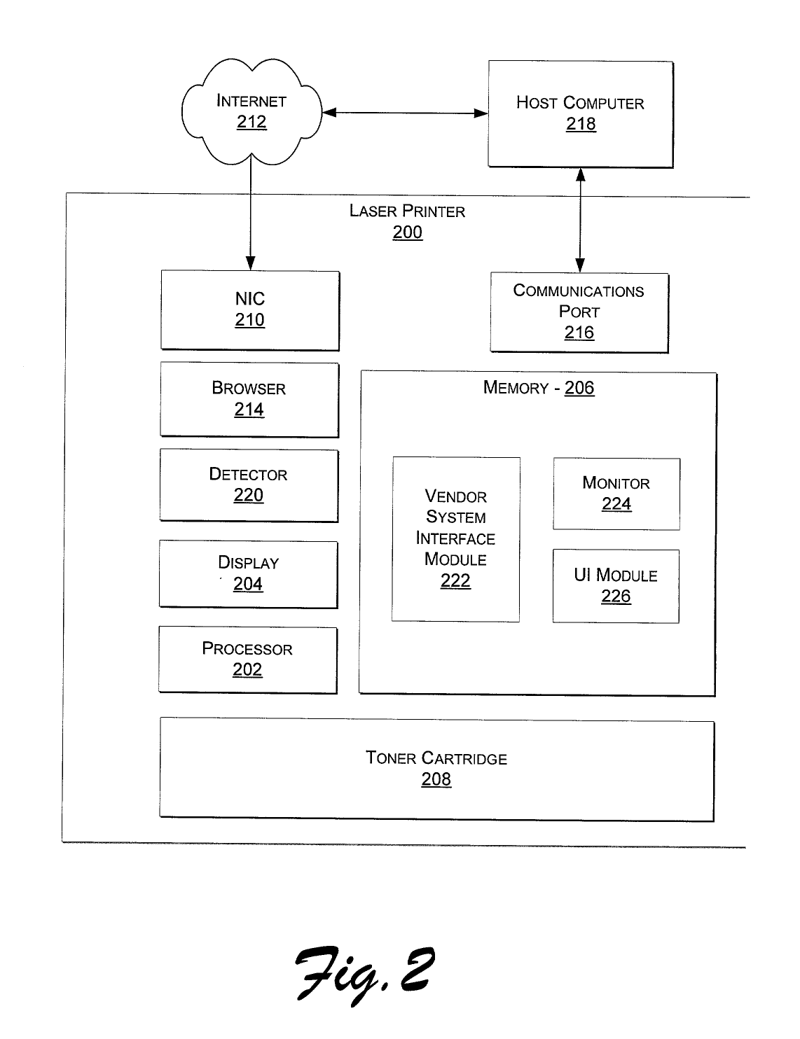

FIG. 2 is a block diagram of a laser printer 200 configured for use in a rules-based printer component management system. Although the present discussion described the laser printer 200, it is noted that the automatic tracking system described herein may be included with any type of printing device such as an inkjet printer, a facsimile machine, a copy machine, etc.—that utilizes replaceable components. It will be recognized by those skilled in the art that many of the features shown in the laser printer 200 and/or the functions performed by those features may be performed as software modules, hardware devices and/or a combination thereof.

The laser printer 200 includes a processor 202, a display 204, memory 206 and a toner cartridge 208. The laser printer 200 also includes a network interface card (NIC) 210 that enables communication with a network, such as the Internet 212 with a web browser 214. A communications port 216 is also includes in the laser printer 200 that enables communication between the laser printer 200 and a host computer 218. As will be discussed in greater detail below, many of the features described for the laser printer 200 may be performed in the host computer 218.

The laser printer 200 further includes a detector 220 that is configured to detect the occurrence of a printer component event within the laser printer 200, such as a low toner event in the toner cartridge 208. The detector 220 is configured to detect printer component events in other components as well as the toner cartridge 208, such as when any component in the laser printer 200 requires replacement because it is inoperable or because a life cycle termination event defined for the component is forthcoming.

The memory 206 of the laser printer 200 includes a vendor system interface module 222 that is configured to interface with the rules-based system 110 (FIG. 1) on the server computer 106 (FIG. 1) of the vendor 100. The method also stores a monitor 224 that is configured to monitor a condition of printer components—such as the toner cartridge 208—in the laser printer 200. This may be accomplished by the monitor 224 by periodically polling the printer components for a condition status or it may be accomplished by the monitor 224 receiving a notification from the detector 220 when a printer component event occurs in a printer component in the laser printer 200.

A user interface module 224 provides a display, which is configured to allow a user to define rules with the rules-based system 110 (FIG. 1) for particular printers. The interface (not shown) may be displayed on the display 204 of the laser printer 200 or, alternatively, on the host computer 208. Furthermore, the host computer 208 may be used to define rules for several printers with the rules-based system 110.

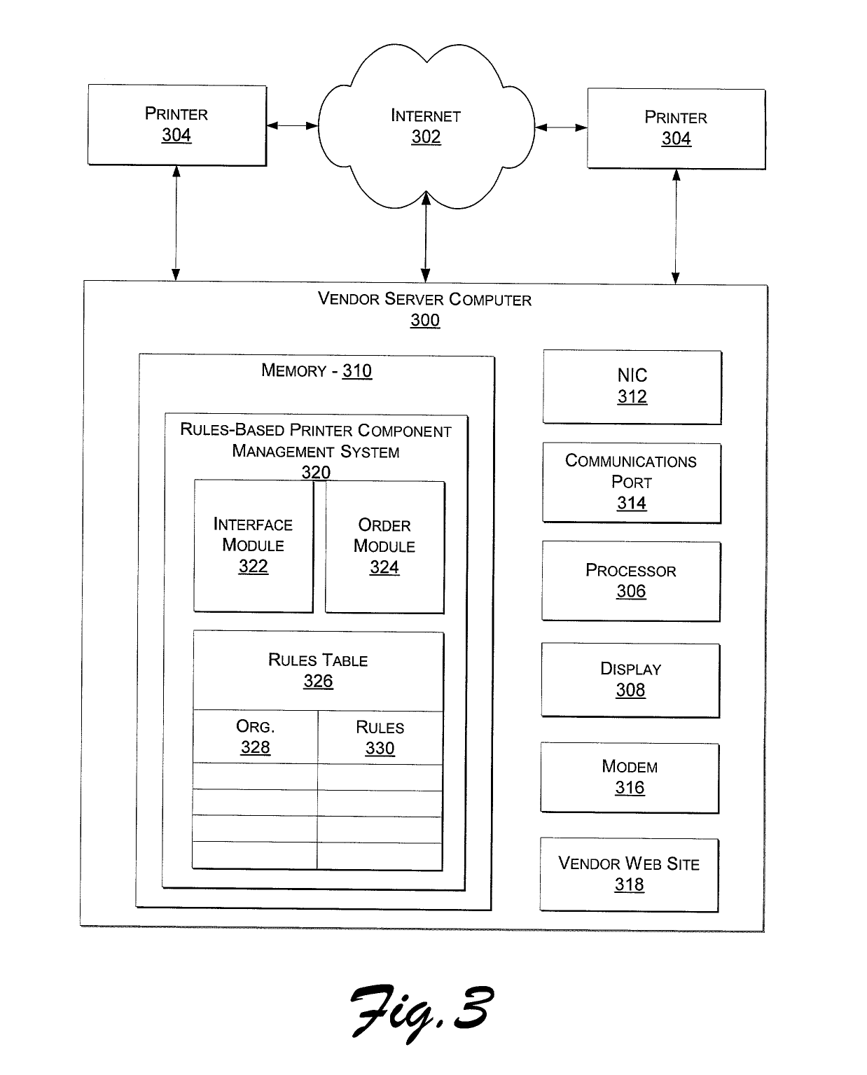

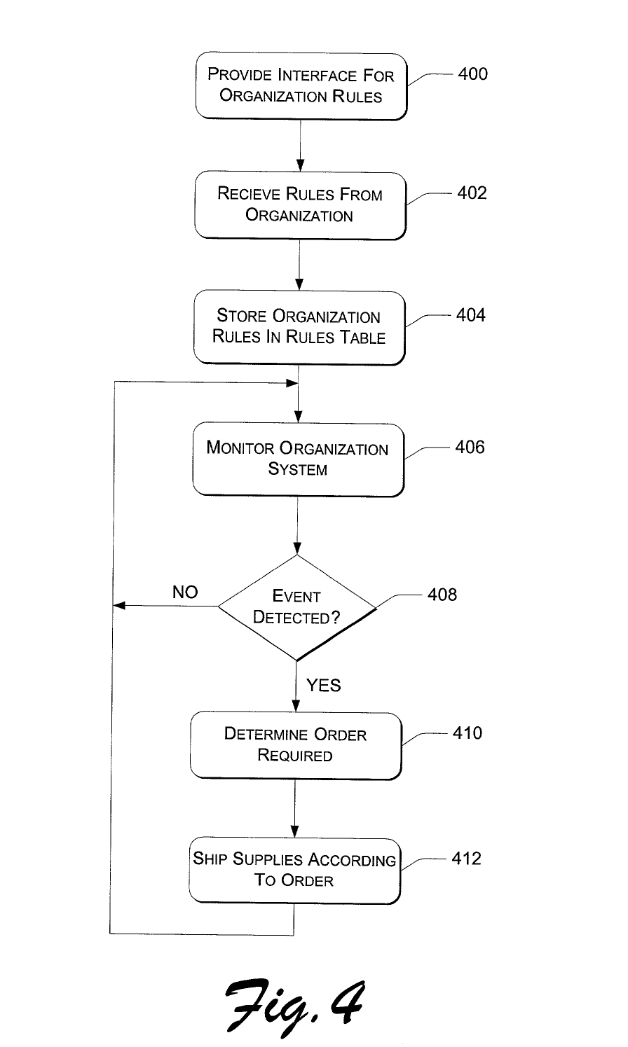

The functions of the features of the laser printer 200 will be described in greater detail, below, in the discussion with reference to FIG. 3 and FIG. 4.

Exemplary Rules-Based Printer Component Management System

FIG. 3 is a block diagram of a vendor server computer 300 similar to the server computer 106 shown in FIG. 1, which provides the rules-based printer component management system described herein. Also shown in FIG. 3 is the Internet 302, which provides a way for the vendor server computer 300 to connect with one or more remote sites and printers 304, such as the organizations (102, 104), computers (114, 116, 120, 122) and printers 118, 124 shown in FIG. 1.

The vendor server computer 300 includes a processor 306, a display 308 and memory 310. For external communications, the vendor server computer 300 is equipped with a network interface card (NIC) 312, a communications port 314 (e.g., a parallel port), and a modem 316. While the vendor server computer 300 is shown as having the NIC 312, the communications port 314 and the modem 316, it is noted that the vendor server computer 300 may have only one or more of these devices, depending on the configuration of the environment of the vendor server computer 300. The vendor server computer 300 hosts a vendor web site 318. Although not shown stored in the memory 310, the vendor web site 318 may be stored in the memory 310 or it may be hosted on a separate device within the vendor server computer 300.

The memory 210 includes a rules-based component management system 320 stored therein. The rules-based component Management system 320 includes an interface module 322, an order module 324 and a rules table 326. The rules table 326 includes an organization column 328 and a rules column 330. Although the example discussed herein refers to the rules-based component management system 320 as being stored in the memory 210 of the vendor server computer 300, it is noted that the rules-based component management system 320 may reside in any printer-related unit within an organization. For example, the rules-based component management system 320 may be implemented in a host computer (not shown) or in a print server (not shown) of an organization.

The interface module 322 is configured to provide an interface to printers and/or computers of multiple organizations. The interface module 322 sends and receives information to organizations 102, 104 (FIG. 1) and computers (114, 116, 120, 122), and printers (118, 124) within the organizations 102, 104.

The interface module 322 allows a user in an organization 102, 104 to define rules for one or more of the printers 118, 124 in the organization. The rules define one or more printer component conditions for the printers 118, 124 that, when occurring, indicate that a printer component requires replacement. The name of the organization 102, 104 is stored in the organization column 328 and the rules associated with the printers 118, 124 are stored in the rules column 330 of the rules table 326.

When the rules-based component management system 320 detects the occurrence of a printer component event, the order module 324 transmits an order for a replacement component to be shipped to the organization 102, 104. If possible, location information about the printers 118, 124 in an organization 102, 104 are stored so that a replacement component may be shipped directly to a location of the printers 118, 124. The order sent by the order module 324 may be an order to an outside supplier (not shown) or it may be an internal order to the shipping department 112 within the vendor's organization 100.

The vendor server computer 300 and its components and features will be described in more detail below, with reference to FIG. 4, in a discussion of a methodological implementation of a rules-based printer component management system.

Methodological Implementation of the Automatic Tracking System

FIG. 4 is a flow diagram depicting a methodological implementation of the rules-based printer component management system described herein. Continuing reference will be made to the elements and reference numerals of the previous figures in the following discussion. At block 400, the interface module 322 of the rules-based printer component management system 320 in the vendor server computer 300 provides an interface (user interface module 226) to an organization to provide rules to govern printer component replacement for the organization. The interface module 322 may provide the interface directly to users within the organization or it may provide software that includes the user interface module 226 a printer or computer within the organization. The user interface module 226 allows entry of rules for one or more than one printer within the organization. If the organization includes more than one location, the user interface module 226 also allows entry of rules for each location of the organization.

At block 402, the rules-based printer component management system 320 receives rules for printers 118, 124 in the organizations 102, 104 by way of the vendor system interface module 222 (in the laser printer 200) or a computer or printer in the organizations 102, 104. The rules 328 received from the organizations 102, 104 are stored in the rules table 326 and associated with the organization (102, 104) 328 at block 404.

The vendor server computer 300 monitors the organization 102, 104 printers 118, 124 and/or computers 114, 116, 120, 122 (block 406) which, in turn, monitor the printers 118, 124. The monitoring may be accomplished by any method known in the art. For example, the monitoring may include periodically polling the printers 118, 124 for conditions of component(s) in the printers 118, 124. When a result of a polling indicates that a printer component event has occurred, a replacement component is ordered to replace the component to which the printer component relates. Alternatively, the monitoring may include receiving a notification from an organization 102, 104 that a printer component event has occurred. This alternative configuration requires that there be two-way communication between the organizations 102, 104 and the vendor server computer 300. The details of such communication will not be discussed herein, in that any method known in the art for implementing such two-way communication may be utilized with the invention.

If a printer component event occurs and is detected (“Yes” branch, block 408), then the requirements of the order are determined (block 410) and an appropriate order is placed. For example, the rules-based component management system 320 would determine what make and model of printer requires a component and which component is required for the particular printer. Placing the order can be accomplished by ordering a component from an outside vendor or by ordering the component to be shipped from the shipping department 112 of the vendor 100.

At block 412, the component(s) is/are shipped to the organization 102, 104 to fulfill the order. As long as no printer component event has not occurred (“No” branch, block 408), the rules-based printer component management system 320 continues to monitor the printers 118, 124 at block 406.

Conclusion

Implementation of the rules-based printer component management system and methods described herein provides a way for printer component vendors to help customers manage their printer components more efficiently and, as a result, retain customers for repeat business.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method for managing printer component inventories, comprising:
defining one or more printer component rules for one or more printers in a first organization and for one or more printers in a second organization, each printer component rule defining a printer component event that, when it occurs, indicates that the printer component requires replacement;
monitoring printer components in the printers in the first organization and the second organization to detect an occurrence of a printer component event defined by a printer component rule; and
replacing a printer component when a printer component event is detected in a printer.

2. The method as recited in claim 1, wherein the replacing the printer component further comprises ordering a replacement component to be shipped to a location of the printer in which the printer component event was detected.

3. The method as recited in claim 1, wherein the replacing the printer component further comprises shipping a replacement component to a location of the printer in which the printer component event was detected.

4. The method as recited in claim 1, wherein the printer component further comprises a printer component selected from the following list of printer components: toner cartridge; ink cartridge; ribbon cartridge; dry medium cartridge; ink bladder; photoconductor; drum; belt; developer assembly; cleaning roller; oiling roller; transfer assemblies; print head.

5. The method as recited in claim 1, wherein:
the printer component is a toner cartridge for a laser printer; and
the printer component event is a low toner condition in the toner cartridge.

6. The method as recited in claim 1, further comprising presenting an interface to the first organization and to the second organization, the interface allowing the first organization and the second organization to define the printer component rules for each respective organization.

7. The method as recited in claim 1, wherein detecting the printer component event further comprises receiving notification from an organization that the printer component event has occurred in one of the printers in the organization.

8. The method as recited in claim 1, wherein the monitoring further comprises periodically polling the printer components of the printers in the first and second organizations.

9. A system for managing printer components in one or more organizations, comprising:
a processor;
memory;
connection means for establishing at least one electronic connection with a first organization and at least one electronic connection with a second organization, each organization having at least one printer that includes one or more printer components;
a rules-based printer component management system configured to monitor the printers in the first and second organizations for the occurrence of a printer component event in a printer component, the occurrence of the printer component event indicating that the printer component requires replacement; and
replacing the printer component in which the printer component event occurred.

10. The system as recited in claim 9, further comprising an order module configured to order a replacement component, and wherein the replacing the printer component further comprises ordering a replacement component to replace the printer component.

11. The system as recited in claim 9, further comprising:
a rules table that stores printer events for one or more printers in one or more organizations; and
an interface module configured to present an interface to the one or more organizations, allowing each organization to enter rules in the rules table for the one or more printers of the organization.

12. The system as recited in claim 9, wherein the connection means further comprises a network interface card that provides a connection with a network.

13. The system as recited in claim 9, wherein the connection means is a modem that provides a telephone line connection with a computing device.

14. The system as recited in claim 9, wherein the rules-based printer component management system monitors the printers by periodically polling a status of the printer components in the printers for the occurrence of a printer component event.

15. The system as recited in claim 9, wherein the rules-based printer component management system monitors the printers by receiving a notification from the printer that a printer component event has occurred.

16. The system as recited in claim 9, wherein the rules-based printer component management system monitors the printers by receiving a notification from the first or second organization that a printer component event has occurred in an organization printer.

17. One or more computer-readable media containing computer-executable instructions that, when executed on a computer, perform the following steps:
monitoring printer component conditions in one or more printers of more than one organization;
referring to printer component rules defined for the one or more printers to determine if a printer component event has occurred that indicates that a replacement component is required for the printer component in which the printer component event has occurred, the printer component even occurring when printer component conditions satisfy at least one of the printer component rules; and
replacing the printer component that requires replacement with a replacement component.

18. The one or more computer-readable media as recited in claim 17, wherein replacing the printer component further comprises ordering the replacement component to be shipped to a location of the printer in which the replacement component is required.

19. The one or more computer-readable media as recited in claim 17, wherein replacing the printer component further comprises shipping the replacement component to a location of the printer in which the replacement component is required.

20. The one or more computer-readable media as recited in claim 17, further comprising additional computer-executable instructions that, when executed on a computer, perform the following step:
presenting an interface to the organizations allowing each organization to define printer component rules for the printers of the organization.

21. The one or more computer-readable media as recited in claim 17, wherein the monitoring printer component conditions further comprises periodically polling the printers to determine the printer component conditions.

22. The one or more computer-readable media as recited in claim 17, wherein the monitoring printer component conditions further comprises receiving notification from an organization when a printer component event has occurred in a printer in the organization.
